(19) United States
(12) Patent Application Publication
(10) Pub. No.: US 2026/0048658 A1
(43) Pub. Date: Feb. 19, 2026

(54) VEHICLE BASED TRAINING SYSTEM AND METHOD

(71) Applicant: Ford Global Technologies, LLC, Dearborn, MI (US)

(72) Inventors: Stuart Salter, White Lake, MI (US); Ryan O'Gorman, Beverly Hills, MI (US); Peter J. Nikolajevs, Dearborn, MI (US); Brendan Diamond, Naples, FL (US); Annette Lynn Huebner, Highland, MI (US)

(21) Appl. No.: 18/802,397

(22) Filed: Aug. 13, 2024

(51) Int. Cl. B60K 35/26; B60L 53/66; G06V 20/56

(52) U.S. Cl. CPC B60K 35/265; B60L 53/66; G06V 20/56

(57) ABSTRACT

Systems and methods for communicating instructions to a user of a vehicle to facilitate charging of a vehicle via a vehicle charger are described. In one example, output of a camera may be a basis for instructions to move the vehicle relative to a position of a vehicle charger. This allows the vehicle and camera to be positioned to monitor the vehicle charger and guide a user through a vehicle charging procedure that includes applying the vehicle charger.

### FIELD

The present description relates to methods and a system for a vehicle based training system for charging a vehicle. The methods and systems may be particularly useful for persons that are inexperienced with particular vehicle chargers.

### BACKGROUND

A vehicle user may wish to charge a vehicle via a commercial vehicle charger or a home vehicle charger. The commercial vehicle charger may be applied to supply electric charge to the vehicle when the vehicle is traveling on long distance trips or if the vehicle is low on charge while traveling. The home charger may supply charge to the vehicle when the vehicle is parked at a user's home. The commercial vehicle charger and the home charger may have different charging capacities, different manufacturers, different operating procedures, and physical profiles. The vehicle user may rely on the home charger to supply charge to the vehicle much of the time as a matter of convenience and to lower the financial expense of operating the vehicle. However, the vehicle user may wish to utilize the commercial charger while traveling and when the user wishes to charge the vehicle in a shorter period of time.

The commercial charger and the home charger may be built by different manufactures. As such, the commercial charger and the home charger may have different operating procedures. Further, the commercial charger may include a payment acceptance step that is not included with the home charger. The differences between the commercial charger and the home charger may cause the user to lack confidence in being able to activate the commercial charger or a home vehicle charger that is at a home that is other than the user's home. Consequently, it may be desirable to provide a way of increasing a user's confidence for being able to charge a vehicle via unfamiliar vehicle chargers.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example electric vehicle and vehicle charger;

FIG. 2 is a perspective view showing an electric vehicle with sensors and actuators for communicating instructions to a user is shown;

FIGS. 3 and 4 show a flowchart of a method for instructing or training a user to charge an electric vehicle at a vehicle charger is shown;

FIGS. 5A and 5B show a plan view illustrating how a user may be instructed to position a vehicle relative to a vehicle charger to enable a system to train the user to charge the vehicle via a charger; and

FIGS. 6A-6D shows an illustration of example vehicle charger menus that may be monitored by a vehicle to determine whether or not a user is performing a vehicle charging sequence as requested via the vehicle.

### DETAILED DESCRIPTION

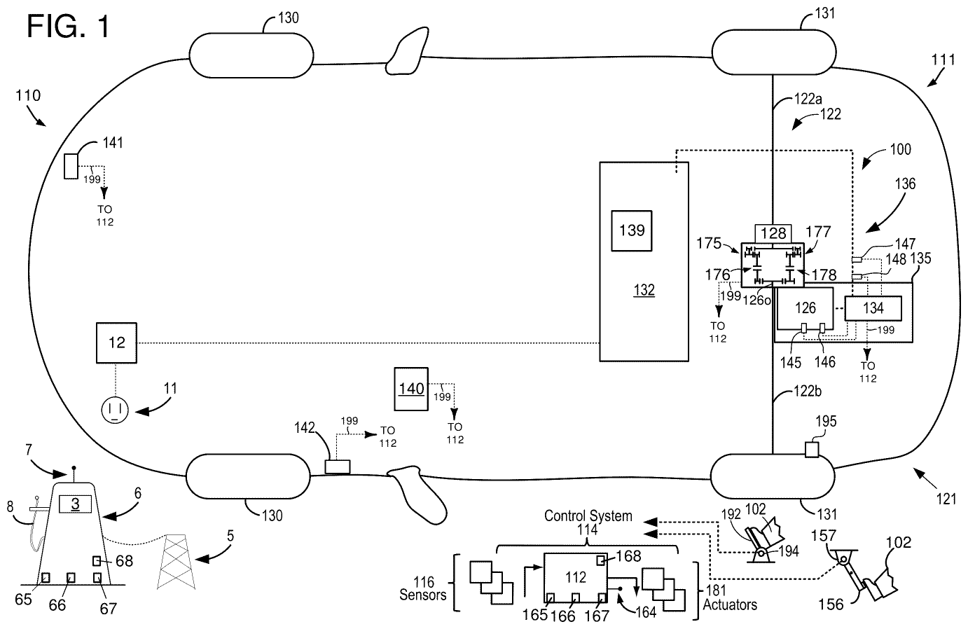

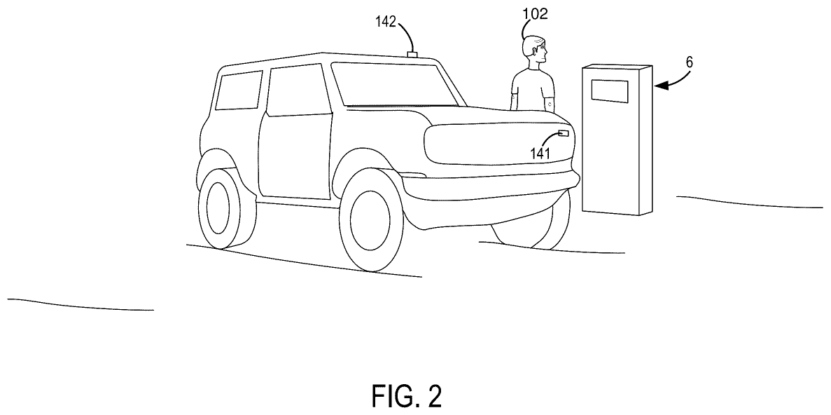

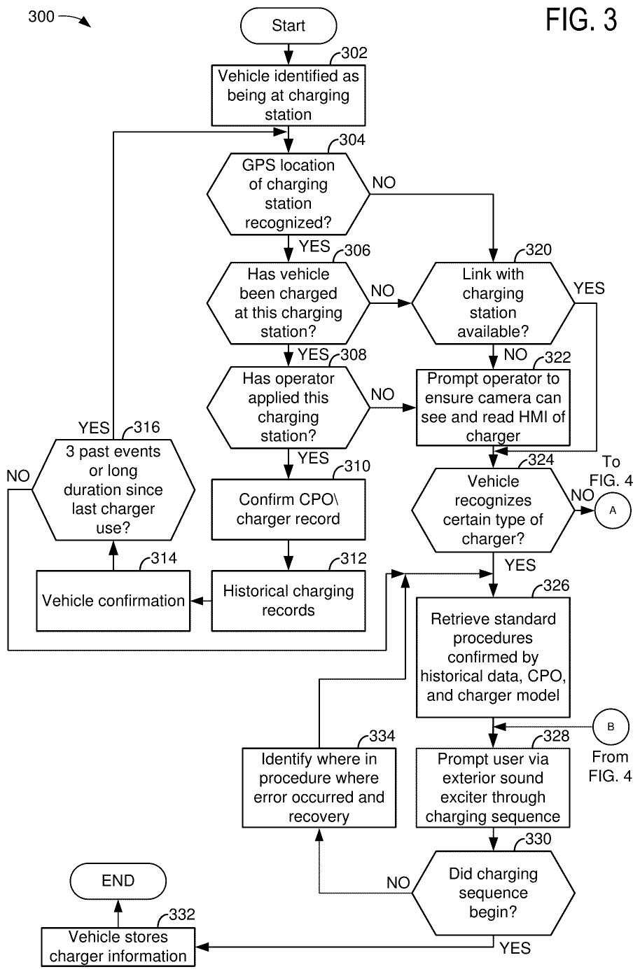

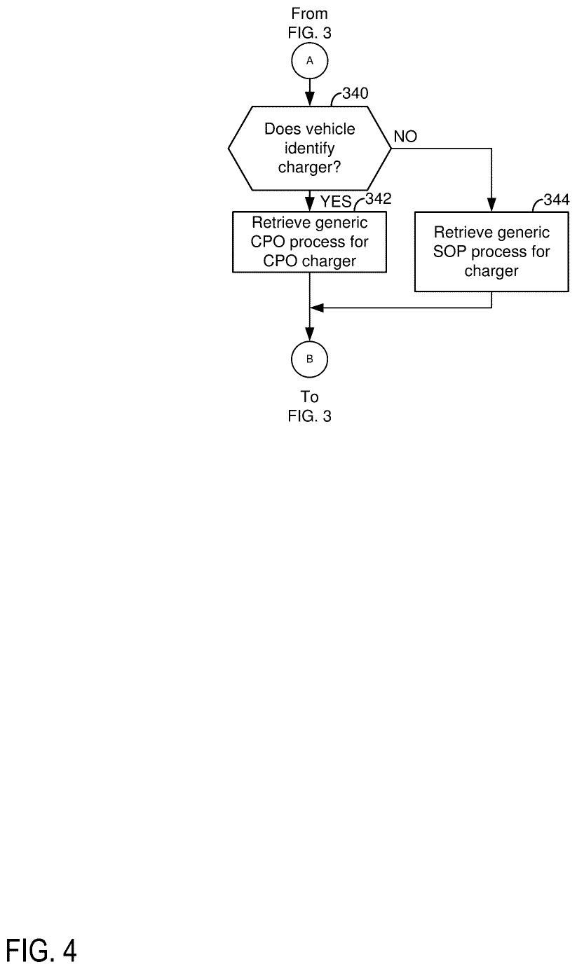

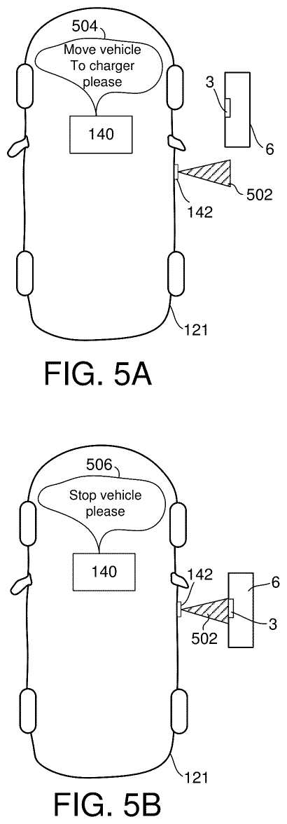

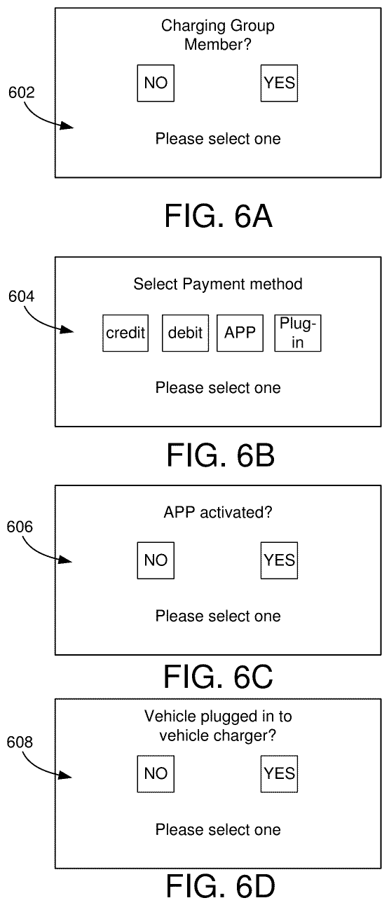

The present description is related to a method and system for instructing a vehicle user how to activate and operate a vehicle charger. The vehicle charger may be a home vehicle charger or a commercial charger and the vehicle charger may be identified by the vehicle. Once the vehicle charger is identified or characterized as a generic vehicle charger, the vehicle may provide instructions to a user to operate the vehicle charger. The vehicle may be a hybrid vehicle or an electric vehicle as shown in FIG. 1. The vehicle may include sensors and actuators to aid the user as shown in FIG. 2. A flowchart of a method for instructing a user how to activate and operate a vehicle charger is shown in FIGS. 3 and 4. A plan view showing how the vehicle may instruct the user how to position the vehicle for charging the vehicle is shown in FIGS. 5A and 5B. A sketch showing example vehicle charger menus that the vehicle may monitor to determine whether or not a user is following vehicle instructions is shown in FIGS. 6A-6D.

Some users may be less sophisticated than other users regarding charging a battery or an electric energy storage device of a vehicle. These less sophisticated users may struggle to activate a vehicle charger or they may take much longer to charge a vehicle when they are introduced to a different or unfamiliar vehicle charger. Additionally, even more sophisticated users may be challenged when they be met with the wide range of vehicle charger interfaces and charger activation sequences that may be provided by charge point operators (CPOs).

The inventors herein have recognized the above-mentioned issues and have developed a vehicle, comprising: a vehicle including a human/machine interface; one or more controllers within the vehicle and including executable instructions that cause the controller to: identify a vehicle charger and provide instructions via the human/machine interface to instruct a procedure for activating the vehicle charger, where the vehicle charger is external to the vehicle.

By identifying a vehicle charger via a vehicle and communicating instructions to operate the vehicle charger so that electric charge may be delivered to a vehicle, it may be possible to provide the technical result of increasing a user's confidence to operate vehicle chargers that the user may be unfamiliar with. Further, communicating instructions to a user may allow the user to begin charging their vehicle sooner as compared to if no instructions are provided to the user to operate the vehicle charger.

The present description may provide several advantages. In particular, the approach may increase user's confidence that they will be able to successfully supply electric charge to their vehicle when using an unfamiliar vehicle charger. Further, the approach may allow a user to supply charge sooner to their vehicle. Additionally, the approach may be useful to allow users that are unfamiliar with a particular vehicle and charger to begin charging a vehicle. As such, the approach may be particularly useful to vehicle rental companies and vehicle renters.

Further, additional technical features of the present application relate to the vehicle-based training system described herein, which implements a specialized machine learning model that is trained on historical charging session data to recognize and classify different types of vehicle chargers based on visual input from the vehicle's camera system. This machine learning model may utilize neural networks to analyze images of charger interfaces in real-time and match them to known charger types and operating procedures stored in the vehicle's onboard database. This addresses technical challenges in compatibility amongst data systems and ensuring accurate allocation of account usage.

The system may integrate data from multiple vehicle sensors, including GPS, cameras, and charging port sensors, to create a comprehensive situational awareness of the charging environment. A sensor fusion approach combines these disparate data streams to precisely localize the vehicle relative to the charger and guide positioning. The vehicle's onboard computer system may further implement a state machine that tracks each step of the charging process, comparing user actions detected by cameras to the expected sequence of operations for the identified charger type. This allows the system to provide real-time feedback and guidance through the human-machine interface.

The charging instruction system may leverage natural language processing to convert technical charging procedures into clear, step-by-step voice commands customized for the specific user based on their experience level and preferences stored in their driver profile. To provide reliable operation across diverse charging stations and/or locations, the system utilizes a distributed ledger to securely share and update a global database of charger information, operating procedures, and user experiences across the fleet of vehicles implementing this technology. This allows the system to rapidly adapt to new charger types and variations in interfaces with reduced processing efficiency and reduced data bandwidth requirements.

The integration of these specialized hardware and software components creates a technological improvement that increases the reliability and efficiency of electric vehicle charging, addressing the technical problem of charger incompatibility and user error in a rapidly evolving charging infrastructure landscape. As described herein the system advantageously utilizes machine learning to process sensor data more accurately, along with the integration of multiple specialized hardware components (e.g., cameras, GPS, charging sensors) to create an improved technological system. The system enables a specific technological improvement (e.g., more reliable EV charging) addressing a technical problem (e.g., charger incompatibility and user error).

The details provided below illustrate an example implementation of complex software methods (e.g., sensor fusion, state machines, natural language processing) that go beyond generic computer functions that leverage distributed computing and secure data sharing to create a continuously improving technological ecosystem.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

FIG. 1 is a schematic diagram of a vehicle 121 including a powertrain or driveline 100. A front portion of vehicle 121 is indicated at 110 and a rear portion of vehicle 121 is indicated at 111. Driveline 100 includes electric machine 126. Electric machine 126 may consume or generate electrical power depending on its operating mode. Throughout FIG. 1, mechanical connections between various components are illustrated as solid lines, whereas electrical connections between various components are illustrated as dashed lines.

Driveline 100 has a rear axle 122. In some examples, rear axle 122 may comprise two half shafts, for example first half shaft 122a, and second half shaft 122b. Driveline 100 also includes front wheels 130 and rear wheels 131. Rear wheels 131 may be driven via electric machine 126.

The rear axle 122 is coupled to electric machine 126. Rear drive unit 136 may transfer power from electric machine 126 to axle 122 resulting in rotation of rear wheels 131. Rear drive unit 136 may include a low gear 175 and a high gear 177 that are coupled to electric machine 126 via output shaft 126o of electric machine 126. Low gear 175 may be engaged via fully closing low gear clutch 176. High gear 177 may be engaged via fully closing high gear clutch 178. High gear clutch 178 and low gear clutch 176 may be opened and closed via commands received by rear drive unit 136 over network 199. Alternatively, high gear clutch 178 and low gear clutch 176 may be opened and closed via digital outputs or pulse widths provided via control system 114. Rear drive unit 136 may include differential gear set 128 so that torque may be provided to first half shaft 122a and to second half shaft 122b. In some examples, an electrically controlled differential clutch (not shown) may be included in rear drive unit 136.

Electric machine 126 may receive electrical power from onboard electric energy storage device 132. Furthermore, electric machine 126 may provide a generator function to convert the vehicle's kinetic energy into electrical energy, where the electrical energy may be stored at electric energy storage device 132 for later use by electric machine 126. An inverter 134 may convert alternating current generated by electric machine 126 to direct current for storage at the electric energy storage device 132 and vice versa. Electric drive system 135 includes electric machine 126 and inverter 134. Electric energy storage device 132 may be a traction battery (e.g., a battery that supplies power to propel a vehicle), capacitor, inductor, or other electric energy storage device. Electric power flowing into electric drive system 135 may be monitored via current sensor 145 and voltage sensor 146. Position and speed of electric machine 126 may be monitored via position sensor 147. Torque generated by electric machine 126 may be monitored via torque sensor 148. In some examples, electric energy storage device 132 may be configured to store electrical energy that may be supplied to other electrical loads residing on-board the vehicle (other than the motor), including cabin heating and air conditioning, engine starting, headlights, cabin audio and video systems, etc.

Control system 114 may communicate with electric machine 126, electric energy storage device 132, etc. Control system 114 may receive sensory feedback information from electric drive system 135 and electric energy storage device 132, etc. Further, control system 114 may send control signals to electric drive system 135 and electric energy storage device 132, etc., responsive to this sensory feedback. Control system 114 may receive an indication of an operator requested output of the vehicle propulsion system from a human operator 102 (e.g., a user), or an autonomous controller. For example, control system 114 may receive sensory feedback from pedal position sensor 194 which communicates with pedal 192. Pedal 192 may refer schematically to a driver demand pedal. Similarly, control system 114 may receive an indication of an operator requested vehicle slowing via a human operator 102, or an autonomous controller. For example, control system 114 may receive sensory feedback from pedal position sensor 157 which communicates with vehicle caliper control pedal 156.

Electric energy storage device 132 may periodically receive electric power via power converter 12 and receptacle 11. Receptacle 11 may receive electric power from a vehicle charger 6 and vehicle charger 6 is remote (e.g., external) from vehicle 121. Vehicle charger 6 may wirelessly communicate with vehicle 121 via transceiver 7 and vehicle charger 6 may include an optional HMI 3 (human/machine interface such as a display and/or keyboard). Alternatively, vehicle charger 6 may communicate with vehicle 121 via charging cable 8 (e.g., a wired connection). Vehicle charger 6 may receive electric power from a stationary power grid 5. Vehicle charger 6 includes non-transitory (e.g., read exclusive memory) 65, random access memory 66, digital inputs/outputs 68, and a microcontroller 67. Microcontroller 67 may send and receive messages via transceiver 7. As a non-limiting example, driveline 100 may be configured as a plug-in electric vehicle (EV), whereby electrical energy may be supplied to electric energy storage device 132 via the power grid (not shown). Alternatively, vehicle 121 may be a plug-in hybrid vehicle.

Electric energy storage device 132 includes an electric energy storage device controller 139. Electric energy storage device controller 139 may provide charge balancing between energy storage element (e.g., battery cells) and communication with other vehicle controllers (e.g., controller 112).

One or more wheel speed sensors (WSS) 195 may be coupled to one or more wheels of driveline 100. The wheel speed sensors may detect rotational speed of each wheel. Such an example of a WSS may include a permanent magnet type of sensor.

Controller 112 may comprise a portion of a control system 114. In some examples, controller 112 may be a single controller of the vehicle. Control system 114 is shown receiving information from a plurality of sensors 116 (various examples of which are described herein) and sending control signals to a plurality of actuators 181 (various examples of which are described herein). As one example, sensors 116 may include tire pressure sensor(s) (not shown), wheel speed sensor(s) 195, etc. In some examples, sensors associated with electric machine 126, wheel speed sensor 195, etc., may communicate information to controller 112, regarding various states of electric machine operation. Controller 112 includes non-transitory (e.g., read exclusive memory) 165, random access memory 166, digital inputs/outputs 168, and a microcontroller 167. Infotainment system 140 (e.g., a human/machine interface) may receive input data from human 102 and may display messages and data to human 102. Infotainment system 140 may communicate to controller 112 via network 199 (e.g., a controller area network (CAN) or an Ethernet network). Infotainment system 140 and/or controller 112 may also communicate with camera 142 and audible actuator 141 (e.g., a speaker or other sound exciter) via network 199. Although one camera is shown, it may be appreciated that a vehicle may include a plurality of cameras that provide different views of areas that surround vehicle 121. Controller 112 may communicate with vehicle charger 6 via transceiver 164.

Referring now to FIG. 2, a perspective view of an example vehicle 121 with sensors and actuators for communicating instructions to a user 102 is shown. In this view, audible actuator 141 is positioned on an exterior side of vehicle 121. This may allow human 102 to hear instructions and notifications that may be provided via controller 112 and/or other controllers. Further, camera 142 is shown on an exterior side of vehicle 121 so that it may have a view of vehicle charger 6.

Thus, the system of FIGS. 1 and 2 provides for a vehicle system, comprising: a vehicle including human/machine interface and one or more controllers within the vehicle and including executable instructions stored in non-transitory memory that cause the controller to: identify a vehicle charger and provide instructions via the human/machine interface to instruct a procedure for activating the vehicle charger, where the vehicle charger is external to the vehicle. In a first example, the vehicle system includes where activating the vehicle charger includes flowing charge from the vehicle charger to the vehicle. In a second example that may include the first example, the vehicle system includes where the procedure for activating the vehicle charger includes instructions to navigate through menus of the vehicle charger. In a third example that may include one or both of the first and second examples, the vehicle system includes where the vehicle charger is identified via a wireless connection between the one or more controllers and the vehicle charger. In a fourth example that may include one or more of the first through third examples, the vehicle system includes where the vehicle charger is identified via a camera. In a fifth example that may include one or more of the first through fourth examples, the vehicle system includes where the vehicle charger is identified via a wired connection. In a sixth example that may include one or more of the first through fifth examples, the vehicle system further comprises additional executable instructions that cause the one or more controllers to recognize the procedure is being performed properly.

The system of FIGS. 1 and 2 provides for a vehicle system, comprising: a vehicle including an actuator configured to generate audible output and one or more controllers including executable instructions stored in non-transitory memory that cause the controller to: communicate instructions for proceeding through a vehicle charging procedure via the actuator, where the instructions are based on a vehicle charger external to the vehicle. In a first example, the vehicle system further comprises additional executable instructions that cause the one or more controllers to: communicate instructions to adjust a position of the vehicle with respect to the vehicle charger. In a second example that may include the first example, the vehicle system includes where the instructions are communicated via a human/machine interface. In a third example that may include one or both of the first and second examples, the vehicle system further comprises additional executable instructions that cause the one or more controllers to: monitor the vehicle charger via a camera. In a fourth example that may include one or more of the first through third examples, the vehicle system includes where the instructions to adjust the position of the vehicle are based on output of the camera.

Turning now to FIGS. 3 and 4, a flowchart of a method for instructing or training a user to charge an electric vehicle via a vehicle charger is shown. The method of FIGS. 3 and 4 may be stored as executable instructions in non-transitory memory of one or more controllers. The method of FIGS. 3 and 4 may be incorporated into the system of FIGS. 1 and 2. A controller may change operating states of one or more devices in the real world according to the method of FIGS. 3 and 4. The method of FIGS. 3 and 4 may operate as shown in FIGS. 5A-6D.

At 302, method 300 identified as being at a vehicle charging station. The vehicle may identify that the vehicle is at a vehicle charging station based on GPS data that is received by the vehicle. The GPS data may be applied to reference a data base to determine whether or not the vehicle is at the vehicle charging station.

Additionally, as shown in FIGS. 5A and 5B and discussed herein, method 300 may communicate instructions to move a vehicle so that a charger and/or charger HMI is within a field of view of a vehicle camera. This may help to ensure that the vehicle may monitor the HMI and follow user actions to determine whether or not a user is following instructions that have been provided by the vehicle to initiate vehicle charging. Once method 300 judges that the vehicle is at a vehicle charging station, method 300 proceeds to 304.

At 304, method 300 judges whether or not a global positioning system (GPS) location of the vehicle charging station (e.g., one or more vehicle chargers within a predetermined radius of a GPS vehicle charger location) has been identified by the vehicle. GPS coordinates of the vehicle charging station may be compared to GPS coordinates of vehicle charging stations that the vehicle has previously received charge from. Additionally, the GPS coordinates of the vehicle charging station may be compared to GPS coordinates of vehicle charging stations that are known and in a database of a remote cloud server. If the GPS coordinates of the vehicle charging station match with GPS coordinates of a vehicle charging station that is stored in the vehicle or a remote server, the answer is yes and method 300 proceeds to 306. Otherwise, the answer is no and method 300 proceeds to 320.

At 306, method 300 judges whether or not the vehicle has been charged via a vehicle charger at the charging station. Method 300 may retrieve data from memory (e.g., RAM) that identifies charging stations where the vehicle has received charge. If the vehicle has received charge at the present vehicle charging station, the answer is yes and method 300 proceeds to 308. Otherwise, the answer is no and method 300 proceeds to 320.

At 308, method 300 judges whether or not the present vehicle operator has used or applied the present vehicle charging station to charge the present vehicle. The present vehicle operator may be identified via a particular key fob, input to a human/machine interface, or facial recognition via cameras. The controller may have previously stored data indicating that the present vehicle operator has charged the present vehicle via the present vehicle charging station to controller memory (e.g., random-access memory). The data that indicates who has charged the present vehicle may be stored along with data that identifies which vehicle charging station was applied to charge the vehicle. If method 300 judges that the present vehicle operator has charged the present vehicle at the present charging station, the answer is yes and method 300 proceeds to 310. Otherwise, the answer is no and method 300 proceeds to 322.

At 310, method 300 confirms the CPO charging station record that is presently stored in controller memory and/or a cloud server. In one example, method 300 may access data for the present CPO and charging station and judge whether or not it is the same as data that was provided by the charging station to the vehicle. Method 300 proceeds to 312.

At 312, method 300 may access historical charging records stored in controller memory of the vehicle, or alternatively, a remote cloud server. The vehicle and/or server may store what types of vehicle chargers have been applied in the past to charge the present vehicle along with the identity of the user that applied the vehicle charger. The vehicle may also identify the operating sequence of chargers at the present charging station. The vehicle may retrieve these sequences from its memory or the remote cloud server. The operating sequences for the charger may be based on data from operations manuals. Further, method 300 may retrieve portions of a prior use of the present vehicle charging station to determine the vehicle charging station operating sequence. Prior successful use sequences (e.g., charging sessions where charge was actually delivered from the charging station to the vehicle) comprising images that are stored in memory via a camera may be a basis of information that may be available to communicate to the vehicle user to facilitate vehicle charging. Method 300 proceeds to 314.

At 314, method 300 provides vehicle confirmation. If the vehicle has determined that the operator has charged or has sufficient experience for the present type of charger, no instruction and/or monitoring by the vehicle may be applied. Method 300 proceeds to 316.

At 316, method 300 judges whether or not the vehicle has been charged at the present charging station in at least one of the last most recent three vehicle charging events and/or if the identified vehicle charger has not been applied to charge the present vehicle for a predetermined amount of time. If the vehicle has not been charged via the charger in at least one of the most recent three vehicle charging events or if the identified vehicle charger has not been applied to charge the vehicle within a predetermined amount of time of the present time, the answer is no and method 300 proceeds to 326. Otherwise, the answer is yes and method 300 returns to 304.

At 320, method 300 judges whether or not there is a communication link with the charging station. In one example, the vehicle charger may broadcast a signal to the vehicle. The signals may be exchanged between the vehicle charger and the vehicle via wired or wireless connection. The vehicle charger identification data (e.g., charger manufacturer, charger model, charger serial number, etc.) may be communicated to the vehicle as the vehicle approaches the vehicle charger, or alternatively, after the vehicle charger has been electrically coupled to the vehicle. If method 300 determines that there is a communications link between the vehicle and the vehicle charger, the answer is yes and method 300 proceeds to 324. Otherwise, the answer is no and method 300 proceeds to 322.

At 322, method 300 prompts or instructs the vehicle user to stop the vehicle at a position where a camera may view a human machine interface (HMI) of the vehicle charger. For example, if the vehicle is positioned behind where the camera is positioned behind a centerline of the vehicle charger's HMI, method 300 may audibly or visually provide an indication that the vehicle is to move forward. Alternatively, if the vehicle is positioned ahead of where the camera is positioned ahead of a centerline of the vehicle charger's HMI, method 300 may audibly or visually provide an indication that the vehicle is to move backward. Additionally, method 300 may communicate to the vehicle user if the vehicle is not close enough to the vehicle charger to capture a desirable image of the HMI. For example, method 300 may communicate to the user to pull the vehicle closer to the HMI of the vehicle charger. Method 300 proceeds to 324 after the vehicle user has the vehicle positioned so that the vehicle's camera may get an acceptable view of the vehicle charger's HMI. At 324, method 300 judges whether or not the vehicle recognizes a certain type of charger. Method 300 may recognize the particular vehicle charger when method 300 recalls charging station data from its memory that matches charging station data that is received from the present vehicle charging station. If method 300 judges that the vehicle recognizes the present vehicle charger, the answer is yes and method 300 proceeds to 326. Otherwise, the answer is no and method 300 proceeds to 340.

At 326, method 300 retrieves from memory standard procedures for the recognized vehicle charging station. The standard procedures are confirmed via historical data, CPO, and vehicle charger model. The standard operating procedures may be recited audibly and/or displayed visually as steps for performing vehicle charging via the vehicle charger. The standard operating procedures may be produced via the manufacturer of the vehicle charger and stored as data files in one or more controllers in the vehicle. Historical data from successful charging events where the vehicle actually received charge from the vehicle charger may confirm that the correct vehicle charging procedure is being used for the present vehicle. For example, if it were recorded that the vehicle received charge on a particular earlier date before the present date when a particular charging sequence was presented to the present vehicle's user, then the particular vehicle charging sequence may be a confirmed charging sequence that may be presented to the present vehicle user. Further, a recognized charging station charger and/or vehicle charger model number, may be a confirmation that a particular charging sequence stored in memory of one or more controllers it a relevant charging sequence and the relevant charging sequence may be presented to the user via a human/machine interface and/or an audible actuator. In one example, the standard operating procedure may be stored in controller memory as a file and the controller may have many files for many different chargers stored in memory (e.g., stored in random-access memory). Method 300 proceeds to 328 after a vehicle charging procedure has been retrieved from controller memory.

At 328, the vehicle charging sequence that was retrieved from controller memory is audibly and/or visually presented to the present vehicle user. In one example, an audible actuator generates voice commands and presents the voice commands to the user on the outside of the vehicle. In other examples, an infotainment system may display steps of the vehicle charging process on a display screen. The vehicle's HMI may operate interactively with the user to present the standard operating procedure to the user. For example, the HMI may audibly or visually present a step in the vehicle charging sequence to the user and then wait until the user has confirmed that the user has performed the step. The user may issue voice confirmation or provide tactile input directly to the HMI. The vehicle may also monitor the user's actions via a camera that is mounted on the exterior of the vehicle. In one example, the camera may follow selections of the user that are made on a user interface of the vehicle charger while at the same time the vehicle issues operational instructions of the vehicle charger. The camera may capture images of the vehicle charger's HMI and the images may be compared to HMI screen images that are part of the manufactures standard operating procedure. Method 300 proceeds to 330 after prompting the user to perform the vehicle charging sequence.

At 330, method 300 judges whether or not the vehicle charging sequence began. If the vehicle senses charge flowing to the vehicle, the answer is yes and method 300 proceeds to 332. Otherwise, the answer is no and method 300 proceeds to 334.

At 332, method 300 stores to memory data indicating that charge was successfully delivered to the vehicle a confirmation of the vehicle being charged. Further, method 300 may be stored camera images to controller memory so that these images may be displayed at a later time during a different vehicle charging sequence. Additionally, the user sequence step and images may be exported to a cloud server so that other users may follow the successful vehicle charging procedure. Method 300 proceeds to exit.

At 334, method 300 attempts to determine where in the vehicle charging sequence the user may have erred so that vehicle charging did not commence. By comparing the order that images are displayed on the vehicle HMI with the order of images that are included in the manufactures standard operating procedure or a prior successful operating procedure where charge was delivered by the vehicle charger, the vehicle may determine whether or not the user is following the correct operating procedure. For example, if the sequential order that images are presented on the vehicle charger HMI do not match the sequential order of images that are generated via the vehicle's camera, method 300 may determine that the vehicle's user is not following the prescribed procedure. Method 300 may also determine at what step in the standard operating procedure did an image of the vehicle's HMI not match an image of the manufacture's or previously successful operating sequence. This step may be identified as a possible error by the vehicle user. Method 300 returns to 326.

At 340, method 300 judges whether or not the vehicle recognizes the vehicle charger CPO, vehicle charger manufacturer, and/or vehicle charger model. Method 300 may compare the present vehicle charger identifying attributes (e.g., make, model, serial number) with a list of known charger attributes. If the vehicle matches the present vehicle charger to a vehicle charger attributes stored in controller memory or recognizes the vehicle charger's identity, the answer is yes and method 300 proceeds to 342. Otherwise, the answer is no and method 300 proceeds to 344.

At 342, method 300 retrieves a generic CPO process for the present CPO charger. The generic CPO process may be retrieved from controller memory. The generic CPO may include audible instructions and/or images that may displayed via the vehicle's HMI. Method 300 proceeds to 328.

At 344, method 300 retrieves a generic standard operating procedure (SOP) from controller memory. The SOP may be provided via the vehicle charger's manufacturer. Method 300 proceeds to 328.

Thus, method 300 operates to identify a vehicle charger, and according to the identified charger, present an operating sequence (e.g., audible and/or visual instructions) to a vehicle user. The vehicle user may follow the instructions and the vehicle may follow the user's actions to determine whether or not the user is following the instructions properly. If the vehicle does not receive charge, the vehicle may identify where in an operating sequence the user did not follow the operating sequence as presented.

The method of FIGS. 3 and 4 provides for a method for a vehicle, comprising: via one or more controllers, identifying a vehicle charger, where the vehicle charger is external to the vehicle; and communicating a procedure to activate the vehicle charger via a human/machine interface of the vehicle. In a first example, the method includes where the procedure provides directions to maneuver through one or more menus of the vehicle charger. In a second example that may include the first example, the method includes where communicating the procedure includes providing audible instructions. In a third example that may include one or both of the first and second examples, the method includes where communicating the procedure includes providing instructions for providing payment via the vehicle charger. In a fourth example that may include one or more of the first through third examples, the method further comprises monitoring that the procedure is being performed as instructed. In a fifth example that may include one or more of the first through fourth examples, the method includes where the monitoring is via a camera. In a sixth example that may include one or more of the first through fifth examples, the method includes where the human/machine interface provides audible instructions to communicate the procedure. In a seventh example that may include one or more of the first through fourth examples, the method further comprises storing to controller memory steps performed that resulted in activating the vehicle charger.

Moving on to FIGS. 5A and 5B, an example showing how a vehicle may assist a vehicle user to position a vehicle for charging. The sequence of FIGS. 5A and 5B may be generated via the system of FIGS. 1 and 2 in cooperation with the method of FIGS. 3 and 4.

At FIG. 5A, vehicle 121 is shown approaching vehicle charger 6. Vehicle 121 includes camera 142 and camera 142 has a field of view 502 (e.g., a zone or space where camera may view and recognize HMI menu displays, buttons, etc.). Vehicle charger 6 includes a HMI 3 that may be monitored by camera 142 in order to position vehicle 121 for charging. Camera 142 may capture images within field of view 502 while the vehicle is approaching charger 6 to determine proper positioning of vehicle so that vehicle 121 may monitor user actions and vehicle charger responses when preparing vehicle 121 to be charged. Images from camera 142 may be compared to known vehicle charger images by one or more controllers to determine whether or not vehicle 121 is properly positioned to monitor charger 6. When images from camera 142 do not indicate that HMI 3 is within field of view 502 of camera 142, the vehicle 121 may display or provide an audible prompt to the vehicle user via a message 504 to move the vehicle to the charger. The message may tell the user where to position the vehicle relative to the vehicle charger so that the HMI 3 is within the field of view 502. In the example that is shown in FIG. 5A, the HMI 3 is not within the field of view 502, so infotainment system 140 (e.g., a HMI) communicates the message 504 visually and/or audibly to the vehicle user (not shown).

At FIG. 5B, vehicle 121 is shown at vehicle charger 6. In this view, the vehicle user (not shown) has moved vehicle 121 into field of view 502. Once vehicle 121 has been moved so that HMI 3 is within the field of view 502 of camera 142 as shown, infotainment system 140 communicates with the user (not shown) to stop the vehicle. At this position, camera 142 may generate images of HMI 3 that allow vehicle 121 to monitor menu or switch selections made by the user (not show). One or more controllers may provide a message 506 to a user to stop the vehicle when the vehicle's HMI is in the field of view of camera 142. Based on the selections may by the user, vehicle 121 may determine whether or not the user has followed directions to charge vehicle 121 as prompted by vehicle 121.

Referring now to FIGS. 6A-6D, several example menus that may be monitored via a camera (e.g., 142 of FIG. 1) are shown. The menus 602, 604, 606, and 608 are exemplary in nature and they are not to be construed as constraining the present systems and methods. A camera (not shown) may monitor the user (not shown) and the sequence of menus displayed to determine whether or not the user is following vehicle charging instructions that have been provided by a vehicle (e.g., 121 of FIG. 1).

Note that the example control and estimation routines included herein can be used with various vehicle system configurations. The control methods and routines disclosed herein may be stored as executable instructions in non-transitory memory and may be carried out by the control system including one or more controllers in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, electric and hybrid vehicle configurations could use the present description to advantage.

1. A vehicle system, comprising:
a vehicle including a human/machine interface and one or more controllers including executable instructions stored in non-transitory memory that cause the one or more controllers to: identify a vehicle charger and provide instructions via the human/machine interface to instruct a procedure for activating the vehicle charger, where the vehicle charger is external to the vehicle.

2. The vehicle system of claim 1, where activating the vehicle charger includes flowing charge from the vehicle charger to the vehicle.

3. The vehicle system of claim 1, where the procedure for activating the vehicle charger includes instructions to navigate through menus of the vehicle charger.

4. The vehicle system of claim 1, where the vehicle charger is identified via a wireless connection between the one or more controllers and the vehicle charger.

5. The vehicle system of claim 1, where the vehicle charger is identified via a camera.

6. The vehicle system of claim 1, where the vehicle charger is identified via a wired connection.

7. The vehicle system of claim 1, further comprising additional executable instructions that cause the one or more controllers to recognize the procedure is being performed properly.

8. A method for a vehicle, comprising:
via one or more controllers, identifying a vehicle charger, where the vehicle charger is external to the vehicle; and
communicating a procedure to activate the vehicle charger via a human/machine interface of the vehicle.

9. The method of claim 8, where the procedure provides directions to maneuver through one or more menus of the vehicle charger.

10. The method of claim 8, where communicating the procedure includes providing audible instructions.

11. The method of claim 8, where communicating the procedure includes providing instructions for providing payment via the vehicle charger.

12. The method of claim 8, further comprising monitoring that the procedure is being performed as instructed.

13. The method of claim 12, where the monitoring is via a camera.

14. The method of claim 8, where the human/machine interface provides audible instructions to communicate the procedure.

15. The method of claim 8, further comprising storing to controller memory steps performed that resulted in activating the vehicle charger.

16. A vehicle system, comprising:
a vehicle including an actuator configured to generate audible output and one or more controllers within the vehicle including executable instructions stored in non-transitory memory that cause the one or more controllers to: communicate instructions for proceeding through a vehicle charging procedure via the actuator, where the instructions are based on a vehicle charger external to the vehicle.

17. The vehicle system of claim 16, further comprising additional executable instructions that cause the one or more controllers to: communicate instructions to adjust a position of the vehicle with respect to the vehicle charger.

18. The vehicle system of claim 17, where the instructions are communicated via a human/machine interface.

19. The vehicle system of claim 17, further comprising additional executable instructions that cause the one or more controllers to: monitor the vehicle charger via a camera.

20. The vehicle system of claim 19, where the instructions to adjust the position of the vehicle are based on output of the camera.
